(19) United States
(12) Patent Application Publication
(10) Pub. No.: US 2002/0154527 A1
(43) Pub. Date: Oct. 24, 2002

(54) AC/DC PORTABLE CHARGER FOR Li-ION BATTERIES, CELLULAR TELEPHONES AND PDAS

(76) Inventor: Maks Lin, Chung-Ho City (TW)

Correspondence Address: JACOBSON, PRICE, HOLMAN & STERN, PROFESSIONAL LIMITED LIABILITY COMPANY, 400 Seventh Street, N.W., Washington, DC, 20004, US

(21) Appl. No.: 09/839,170

(22) Filed: Apr. 23, 2001

(51) Int. Cl. H02M 7/04

(52) U.S. Cl. 363/143

(57) ABSTRACT

An AC/DC input mobile charger includes an enclosure with a regulation circuitry, a DC circuitry, a control circuitry, a DC output circuitry and a PCB internally. The regulation circuitry converts AC power into DC current; the DC circuitry connects to at least one battery or the automobile cigarette lighter as input DC power; the DC output circuitry connects to the control circuitry. Either AC power or DC battery (alkaline battery) can be an input source to charge Li-Ion batteries, cellular phones and PDAs.

The output of the DC output circuitry connects to different output wires for different Li-ion batteries, mobile phones and PDAs for charging that saves different chargers for each individual device.

### BACKGROUND OF THE INVENTION

1. Field of the Invention

This invention relates generally to an AC/DC mobile charger and, more specifically, to an AC/DC mobile charger that takes either AC or DC power sources as input to charge Li-Ion batteries, cellular phones and PDAs (Personal Data Assistance).

2. Description of the Prior Art

Heretofore, telecommunication technology advanced, with the popularity of mobile phone, people can be reached anywhere and anytime. Especially in the emergency mobile phones offer the timely effect for all the people. PDA, on the other hand, can help people keep schedule, telephone numbers to avoid the inconvenience of handwriting. PDA also provides other functions, most of all it is mobile so people can carry it everywhere. Mobile phones and PDAs gradually become one of the necessity of daily life.

Mobile phones and PDAs are powered by rechargeable batteries. Those batteries need to be recharged when power is out, however it is not easy to find an AC power outdoors, therefore the mobile phones and PDAs become useless when their power is out.

Each mobile phone and PDA needs individual charger, therefore users have to prepare different chargers for each of them, and too many chargers cause inconvenience and storage problem.

### SUMMARY OF THE INVENTION

It is therefore a primary object of the invention to provide an AC/DC input mobile charger comprising an enclosure with a regulation circuitry, a DC circuitry, a control circuitry, a DC output circuitry and a PCB internally. The regulation circuitry converts AC power into DC current; the DC circuitry connects to at least one battery or the automobile cigarette lighter as input DC power source. The control circuitry connects to both regulation circuitry and DC circuitry and decides which circuitry as input power source. The DC output circuitry connects to the control circuitry. Either AC power or DC battery (alkaline battery) can be an input source to charge Li-Ion batteries, cellular phones and PDAs.

It is still an objective of this invention to provide a AC/DC input mobile charger in which output of the DC output circuitry connects to different output wires for different Li-ion batteries, mobile phones and PDAs for charging that saves different chargers for each individual device.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is a perspective view of the present invention;

FIG. 2 is a circuit block diagram of the present invention; and

FIG. 3 is a circuit diagram of the present invention.

### DESCRIPTION OF THE PREFERRED EMBODIMENT

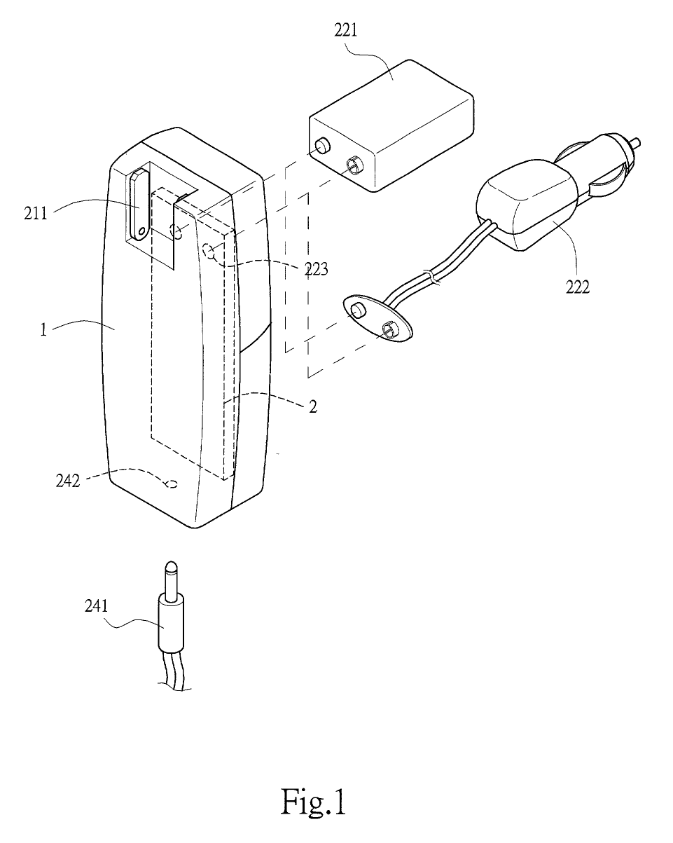

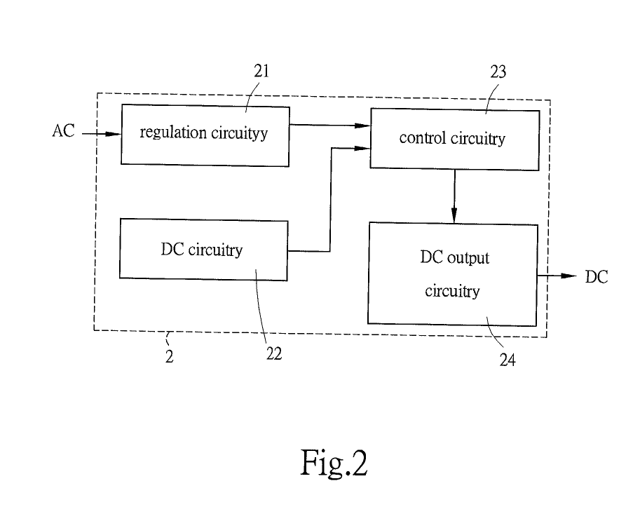

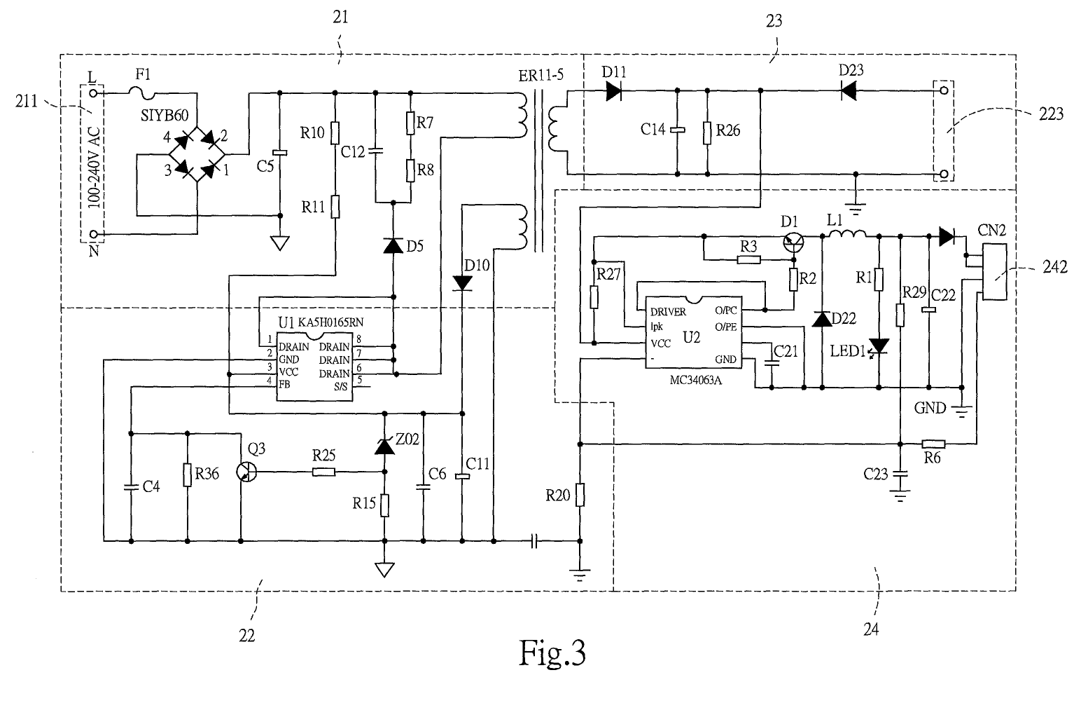

Referring to FIG. 1, the present invention is composed of an enclosure 1 with a regulation circuitry 21, a DC circuitry 22, a control circuitry 23, a DC output circuitry 24 and a PCB 2 internally, as shown in FIG. 2 and FIG. 3. The functions of each component are described below:

The regulation circuitry 21 connects to alternate current power source with an AC input plug 211. The regulation circuitry 21 converts input AC power into DC current.

The DC circuitry 22 connects to at least one battery (alkaline battery) 221 or to the automobile cigarette lighter 222 as DC power input.

The control circuitry 23 connects to both the regulation circuitry 21 and the DC circuitry 22, it controls the input charging source: the regulation circuitry 21 or the DC circuitry 22.

The DC output circuitry 24 connects to the control circuitry 23. The output end 242 of the DC output circuitry 24 can tie to different output wire 241 with different resistors of different resistant values for different charging voltage levels for Li-Ion batteries, cellular phones and PDAs.

Based on above description, when Li-Ion batteries, cellular phones or PDAs are charged with AC input, a right output wire 241 is to choose first and connect to the output 242 of the DC output circuitry 24. The other end of the output wire 241 then is connected to a Li-Ion battery, cellular phone or PDA for charging.

While outdoors, AC power is not available for charging, a battery (alkaline battery) 221, a 9V battery for example, can be applied. Connect a battery (alkaline battery) 221 to the DC charging input connector 223 of the DC circuitry 23 to charge Li-Ion battery, cellular phone or PDA without AC power.

The output 242 of the DC output circuitry 24 connects to Li-Ion battery, cellular phone or PDA through an output wire 241 for charging, therefore such mechanism can save different kind of chargers for each individual device that reduces troublesome for storing and inconvenience for charging.

AC input plug 211 of the regulation circuitry 21 is foldable inside the enclosure 1 to reduce the physical size, it can be bent to the right position for AC wall outlet while charging.

While a preferred embodiment of the invention has been shown and described in detail, it will be readily understood and appreciated that numerous omissions, changes and additions may be made without departing from the spirit and scope of the invention.

What is claimed is:

1. An AC/DC input mobile charger comprising:
an enclosure,
a regulation circuitry converting input AC power into DC current and having an AC input plug for connecting to alternating current power source,
a DC circuitry connecting to at least one battery (alkaline battery) or connecting to the automobile cigarette lighter as DC current input,
a control circuitry connecting to both said regulation circuitry and said DC circuitry and controlling the output charging source—said regulation circuitry or said DC circuitry,
a DC output circuitry connecting to said control circuitry and used for charging Li-Ion batteries, cellular phones and PDAs.

2. The AC/DC input mobile charger recited in claim 1, wherein the output end of said DC output circuitry is connected to different output wires with different resistors of different resistant values for different charging voltage levels for Li-Ion batteries, cellular phones and PDAs.
